(19) United States
(12) Patent Application Publication
(10) Pub. No.: US 2024/0144104 A1
(43) Pub. Date: May 2, 2024

(54) WORKLOAD PERFORMANCE PREDICTION

(71) Applicant: HEWLETT-PACKARD DEVELOPMENT COMPANY, L.P., Spring, TX (US)

(72) Inventors: Byron A ALCORN, Fort Collins, CO (US); Ewerton LOPES SILVA DE OLIVEIRA, Porto Alegre (BR); Marco AURELIO DA SILVA CRUZ, Porto Alegre (BR)

(21) Appl. No.: 18/548,202

(22) PCT Filed: Mar. 19, 2021
(86) PCT No.: PCT/US2021/023161

§ 371 Date: Aug. 28, 2023

(51) Int. Cl. G06N 20/00

(52) U.S. Cl. CPC G06N 20/00

(57) ABSTRACT

For each of a number of workloads, first time-series execution performance information is collected during execution of the workload on a first hardware platform. For each workload, second time-series execution performance information is collected during execution of the workload on a second hardware platform. An encoder-decoder machine learning model is trained that outputs predicted performance on the second hardware platform relative to known performance on the first hardware platform. The encoder-decoder machine learning model is trained from the first and second time-series execution performance information for each workload.

### BACKGROUND

Computing devices, such as desktop, laptop, and notebook computers, as well as smartphones, tablet computing devices, and other types of computing devices, are used to perform a variety of different processing tasks to achieve desired functionality. A workload may be generally defined as the processing task or tasks, including which application programs perform such tasks, that a computing device executes on the same or different data over a period of time to realized desired functionality. Among other factors, the constituent hardware components of a computing device, including the number or amount, type, and specifications of each hardware component, can affect how quickly the computing device executes a given workload.

### BRIEF DESCRIPTION OF THE DRAWINGS

FIG. 1 is a flowchart of an example method for training an encoder-decoder machine learning model that predicts performance of execution of a workload on a second hardware platform relative to known performance of execution of the workload on a first hardware platform.

FIG. 2 is diagram of example execution performance information collected on a first hardware platform while the first platform is executing a workload and example aggregation of the collected execution performance information.

FIG. 3 is a diagram illustratively depicting an example of input on which basis an encoder-decoder machine learning model is trained to predict performance of workload execution on a second hardware platform relative to known performance of workload execution on a first hardware platform, as in FIG. 1.

FIG. 4 is a diagram of an example encoder-decoder machine learning model for predicting performance of workload execution on a second hardware platform relative to known performance of workload execution on a first hardware platform, in the context of training the model as in FIGS. 1 and 3.

FIG. 5 is a flowchart of an example method for using an encoder-decoder machine learning model trained as in FIGS. 1, 3, and 4 to predict performance of execution of a workload on a second hardware platform relative to known performance of execution of the workload on a first hardware platform.

FIG. 6 is a diagram illustratively depicting an example of input on which basis a machine learning model is used to predict performance of workload execution on a second hardware platform relative to known performance of workload execution on a first hardware platform, as in FIG. 5.

FIG. 7 is a flowchart of an example method.

FIG. 8 is a diagram of an example non-transitory computer-readable data storage medium.

### DETAILED DESCRIPTION

As noted in the background, the number or amount, type, and specifications of each constituent hardware component of a computing device can impact how quickly the computing device can execute a workload. Examples of such hardware components include processors or compute units (CPUs), memory, network hardware, and graphical processing units (CPUs), among other types of hardware components. The performance of different workloads can be differently affected by distinct hardware components. For example, the number, type, and specifications of the processors of a computing device can influence the performance of processing-intensive workloads more than the performance of network-intensive workloads, which may instead be more influenced by the number, type, and specifications of the network hardware of the device.

In general, though, the overall constituent hardware component makeup of a computing device affects how quickly the device can execute on a workload. The specific contribution of any given hardware component of the computing device on workload performance is difficult to assess in isolation. For example, a computing device may have a processor with twice the number of CPU cores as the processor of another computing device, or may have twice the number of processors. However, the performance benefit in executing a specific workload on the former computing device instead of on the latter computing device may still be minor, even if the workload is processing intensive. This may be due to how the processing tasks making up the workload leverage a computing device's processors in operating on data, due to other hardware components acting as bottlenecks on workload performance, and so on.

Techniques described herein provide for an encoder-decoder machine learning model to predict workload performance on a target hardware platform relative to known workload performance on a source hardware platform. Time-series execution performance information for a workload is collected during execution of the workload on the source hardware platform and input into the model. The machine learning model in turn outputs predicted performance of the workload on the target hardware platform relative to known performance on the source hardware platform. For example, the model may output a ratio of the predicted execution time of the workload on the target hardware platform relative to the known execution time of the workload on the source hardware platform.

The usage of an encoder-decoder machine learning model, as opposed to a different type of machine learning model, can permit model training scalability and performance predictions that do not depend upon complex time interval splits that can be subjective and non-systematic. Existing machine learning approaches that predict workload performance on a target hardware platform relative to known workload performance on a source hardware platform normally rely on segmentation of time-series execution performance information. Such segmentation may be achieved in one of two different ways.

First, by instrumenting the source code of the workload so that corresponding intervals within the time-series execution performance information can be easily identified on both source and target hardware platforms. This process is also known as time-flagging. However, the workload source code may not be available, and even if available, the source code instrumentation process can be laborious. Second, the source time-series execution performance information and the target time-series execution performance information may be correlated with one another after having been collected during workload execution in order to identify corresponding source and target time intervals. However, correlation in this case is unlikely to be accurate and any correlation errors in this respect can affect accuracy of the resultantly trained machine learning model.

By comparison, the usage of an encoder-decoder machine learning model as in the techniques described herein does not require the identification of corresponding time intervals within the time-series execution performance information collected during workload execution on the source and target platforms. Rather, the encoder-decoder machine learning model is trained on the basis of just the overall time-series execution performance information collected during workload execution on the source and target hardware platforms. Specifically, for a given set of workloads, the encoder-decoder machine learning model is trained to estimate the time-series execution performance information if that set of workloads were executed on the target platform. Concretely, the model creates a mapping between executions on the source platform and the target platform. It is the similarity between a new, never seen before workload on the source hardware platform with the workloads used during training (i.e., creation of the mapping) that allows the model to estimate how those unseen workloads will perform on the target hardware platform.

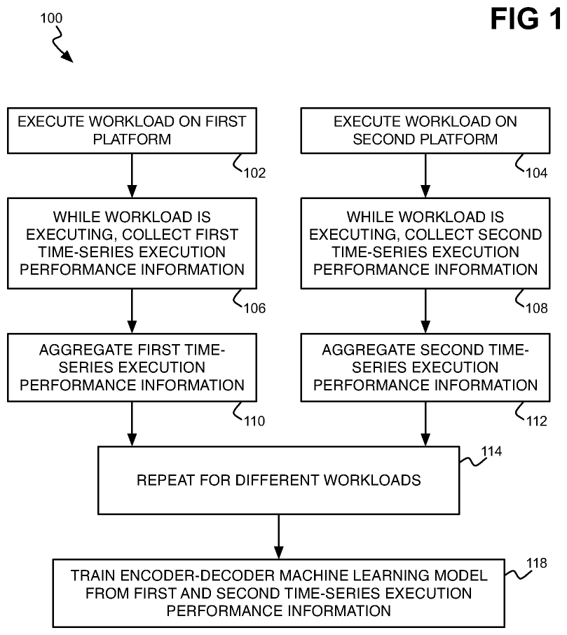

FIG. 1 shows an example method 100 for training an encoder-decoder machine learning model to predict performance of a workload on a second hardware platform relative to known performance of the workload on a first hardware platform. The method 100 can be implemented as a non-transitory computer-readable data storage medium storing program code executable by a computing device. The machine learning model is trained on training workloads executed on the first and second hardware platforms, and then can be subsequently used to predict workload performance on the second hardware platform relative to known workload performance on the first hardware platform. The first hardware platform can also be referred to as a source hardware platform, and the second hardware platform can also be referred to as a target hardware platform.

The method 100 includes executing a training workload on each of the first hardware platform (102) and the second hardware platform (104), which may be considered training platforms. A hardware platform can be a particular computing device, or a computing device that with particularly specified constituent hardware components. The training workload may include one or more processing tasks that specified application programs run on provided data in a provided order. The same training workload is executed on each hardware platform.

The method 100 includes, while the workload is executing on the first hardware platform, collecting first time-series execution performance information of the workload on the first hardware platform (106), and similarly, while the workload is executing on the second hardware platform, collecting second time-series execution information of the workload on the second hardware platform (108). For example, the same data collection computer program may be installed on each hardware platform, which collects the time-series execution performance information from the time that workload execution has started to the time that workload execution has finished on the platform in question.

The time-series execution performance information that is collected on a hardware platform can include values of hardware and software statistics, metrics, counters and, traces over time as the hardware platform executes the training workload. The execution performance information is a time series in that the information includes such values as may be discretely sampled at each of a number of regular time periods, such as every millisecond, every second, and so on. The execution performance information is collected at the same (i.e., identical) fixed intervals, or time periods, on each hardware platform. This permits performance on the second hardware platform to be compared to the performance on the first hardware platform by comparing the length of the time series on the second platform with the length of the time series collected on the first platform.

The execution performance information can include processor-related information, GPU-related information, memory-related information, and information related to other hardware and software components of the hardware platform. The information can be provided in the form of collective metrics over time, which can be referred to as execution traces. Such metrics can include statistics such as percentage utilization, as well as event counter values such as the number of input/output (I/O) calls.

Specific examples of processor-related execution performance information can include total processor usage; individual processing core usage; individual core frequency; individual core pipeline stalls; processor accesses of memory; cache usage, number of cache misses, and number of cache hits in different cache levels; and so on. Specific examples of GPU-related execution performance information can include total GPU usage; individual GPU core usage; GPU interconnect usage; and so on. Specific examples of memory-related execution performance information can include total memory usage; individual memory module usage; number of memory reads; number of memory writes; and so on. Other types of execution performance information can include the number of I/O calls; hardware accelerator usage; the number of software stack calls; the number of operating system calls; the number of executing processes; the number of threads per process; network usage information; and so on.

The time-series execution performance information that is collected does not, however, include the workload itself. That is, the collected execution performance information does not include the specific application programs, such as any code or any identifying information thereof, that are run as processing tasks as part of the workload. The collected execution performance information does not include the (user) data on which such application programs are operative during workload execution, or any identifying information thereof. The collected execution performance information does not include the order of operations that the processing tasks are performed on the data during workload execution. The time-series execution performance information, in other words, is not specified as to what application programs a workload runs, the order in which they are run, or the data on which they are operative. Rather, the time-series execution performance information is specified as to observable and measurable information of the hardware and software components of the hardware platform itself while the platform is executing the workload, such as the aforementioned execution traces (i.e., collected metrics over time).

The method 100 can include aggregating, or combining, the first time-series execution performance information collected on the first hardware platform (110), as well as the second time-series execution performance information collected on the second hardware platform (112). Such aggregation or combination can include preprocessing the collected time-series execution performance information so that execution performance information pertaining to the same hardware component is aggregated, which can improve the relevancy of the collected information for predictive purposes. As an example, the computing device performing the method 100 may aggregate fifteen different network hardware-related execution traces that have been collected into just one network hardware-related execution trace, which reduces the amount of execution performance information on which basis machine learning model training occurs.

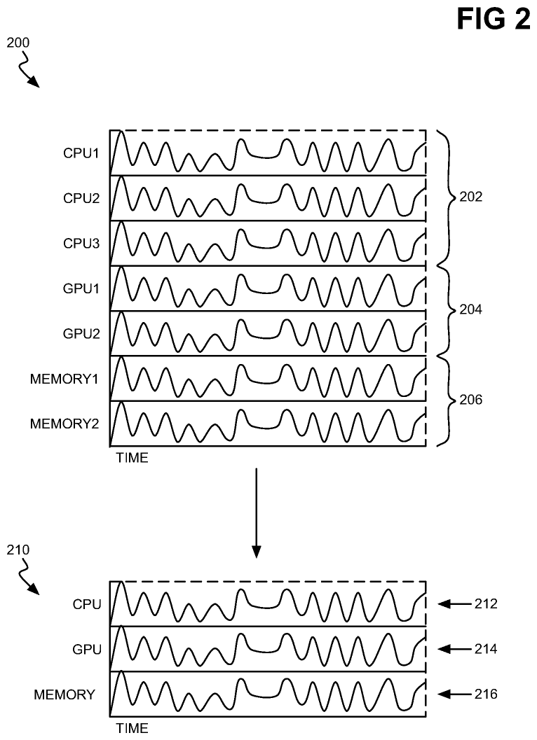

FIG. 2 illustratively shows example time-series execution performance information 200 collected in part 106 or 108 on a hardware platform during execution of a work on the platform in part 102 or 104, as well as aggregation of such time-series execution performance information 200 as the example aggregated time-series execution performance information 210 in part 110 or 112 as to this platform. In the example of FIG. 2, the execution performance information 200 includes three processor (e.g., CPU)-related execution traces 202 (labeled CPU1, CPU2, and CPU3), two GPU-related execution traces 204 (labeled GPU1 and GPU2), and two memory-related execution traces 206 (labeled MEMORY1 and MEMORY2). Each of the execution traces 202, 204, and 206 is a measure of a metric over time, and thus is a time series, where the traces 202 are different CPU-related execution traces, the traces 204 are different GPU-related execution traces, and the traces 206 are different memory-related execution traces. It is noted that in FIG. 2 as well as in other figures in which execution traces are depicted, the execution traces are depicted as identical for illustrative convenience, when in actuality they will in all likelihood differ from one another.

In the example of FIG. 2, each of the execution traces 202, 204, and 206 is depicted as a function to represent that the execution traces 202, 204, and 206 can each include values of a corresponding metric collected at each discrete point in time. For example, the metrics may be collected every t milliseconds. In another implementation, however, each of the execution traces 202, 204, and 206 may include averages of the values of a metric collected over consecutive time periods T, where Tis equal to N×t and N is greater than one (i.e., where each time period T spans multiple samples of the metric). Such an implementation reduces the amount of data on which basis the machine learning model is subsequently trained.

In the example of FIG. 2, the time-series execution performance information 200 has been aggregated (i.e., combined) into aggregated time-series execution performance information 210. Specifically, the processor-related execution traces 202 have been aggregated, or combined, into one aggregated processor-related execution trace 212, the GPU-related execution traces 204 have been aggregated, or combined, into one aggregated GPU-related execution trace 214, and the memory-related execution traces 206 have been aggregated, or combined, into one aggregated memory-related execution trace 216. Aggregation or combination of the execution traces that are related to the same hardware component can include normalizing the execution traces to a same scale, which may be unitless, and then averaging the normalized execution traces to realize the aggregated execution trace in question. In one implementation, the aggregated execution traces 212, 214, and 216 may themselves be aggregated into a single execution trace that serves as the example aggregated time-series execution performance information 210 in part 110 or 112 of the method 100.

Referring back to FIG. 1, the method 100 includes repeating the process of parts 102-112 for each of a number of different training workloads on the same two hardware platforms (114). Therefore, for each training workload, the method 100 includes collecting time-series execution performance information while executing the workload on each of the first and second hardware platforms, and then aggregating the time-series execution performance information on each platform if desired. The result is training data, on which basis an encoder-decoder machine learning model can then be trained.

Specifically, the encoder-decoder machine learning model is trained from the first time-series execution performance information that has been collected on the first hardware platform in part 102 and the second time-series execution performance information that has been collected on the second hardware platform in part 104 (118). If the first time-series execution performance information has been aggregated in part 110 and the second time-series execution performance information has been aggregated in part 112, then the machine learning model may be trained based on the aggregated first and second time-series execution performance information. The machine learning model is trained so that given the actual first time-series execution performance information collected during execution of a training workload on the first platform, the model accurately estimates the actual second time-series execution performance collected during execution of the training workload on the second platform.

In the implementation of FIG. 1, the encoder-decoder machine learning model is specific and particular to predicting workload performance on the second hardware platform relative to known workload performance on the first hardware platform. That is, the model may be not be able to be used to predict performance on a target hardware platform other than the second hardware platform, and may not be able to be used to predict such performance in relation to known performance on a source hardware platform other than the first hardware platform. This is because the machine learning model is not trained using any information of the constituent hardware components of either the first or second hardware platform, and therefore may not be able to be generalized to make performance predictions with respect to any target platform other than the second platform, nor in relation to any source hardware other than the first platform. In such an implementation, the machine learning model is also directional, and may not be able to predict relative performance on the first platform from known performance on the second platform, although another model can be trained in this respect from the same execution performance information collected in parts 106 and 108.

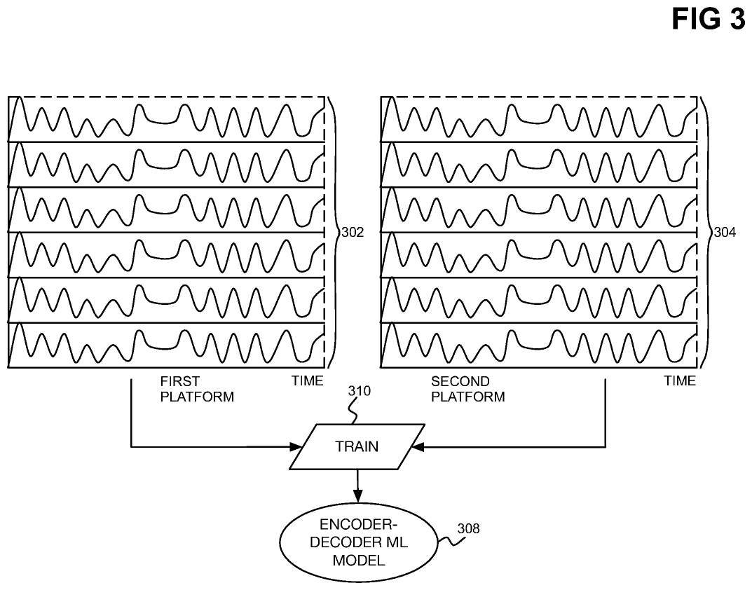

FIG. 3 illustratively shows example encoder-decoder machine learning model training in part 118 of FIG. 1. Machine learning model training 310 occurs on the basis of both the time-series execution performance information 302 and 304. The time-series execution performance 302 is collected in part 106 during workload execution on the first hardware platform in part 102 (and which may be aggregated in part 110). The time-series execution performance information 304 is collected in part 108 during workload execution on the second hardware platform in part 104 (and which may be aggregated in part 112). The execution performance information 302 and 304 are depicted in FIG. 3 as to a single training workload, but in actuality machine learning model training 310 occurs using such execution performance information 302 and 304 for each of a number of training workloads. The output of the machine learning model training 310 is a trained encoder-decoder machine learning model 308 that can predict performance of new workloads on the second platform relative to its known collected performance on the first platform.

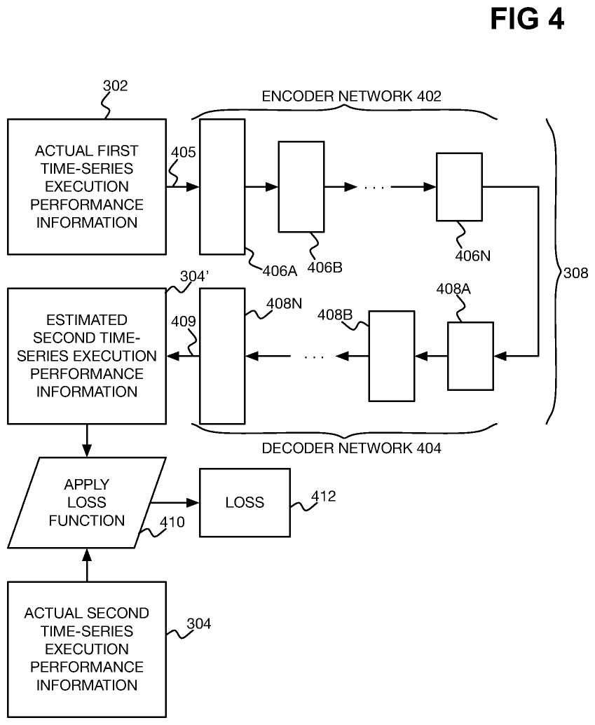

FIG. 4 shows an example encoder-decoder machine learning model 308 for predicting performance of workload execution on a second hardware platform relative to known performance of workload execution on a first hardware platform, in the context of training the model as in FIGS. 1 and 3. The actual first time-series execution performance information 302 collected during execution of a training workload on the first platform is thus depicted in FIG. 4. Similarly, the actual second time-series execution performance information 304 collected during execution of the training workload on the second platform is depicted in FIG. 4.

The encoder-decoder machine learning model 308 may be a neural network machine learning model, such as a convolutional neural network machine learning model, and includes an encoder network 402 followed by a decoder network 404. The encoder and decoder networks 402 and 404 may likewise each be a neural network, such as a convolutional neural network. The encoder network 402 includes a number of encoder layers 406A, 406B, . . . , 406N, collectively referred to as the encoder layers 406, and the decoder network 404 includes a number of decoder layers 408A, 408B, . . . , 408N, collectively referred to as the decoder layers 408. The number of encoder layers 406 may be equal to or different than the number of decoder layers 408. In one implementation, there may be skip connections between the encoder layers 406 and corresponding of the decoder layers 408.

The actual first time-series execution performance information 302 for a workload is input (405) into the first encoder layer 406A of the encoder network 402. The encoder layers 406 encode the first time-series execution performance information 302 via sequentially performed convolutional or other types of operations into an encoded representation, which is then input into the first decoder layer 408A of the decoder network 404. The decoder layers 404 sequentially decode the encoded representation of the first time-series execution performance information 302, again via sequentially performed convolutional operations, into a decoded representation, which is output (409) from the last decoder layer 408N of the decoder network 404 as the estimated second time-series execution performance information 304′. The estimated performance information 304′ can also be referred to as predicted or reconstructed such information.

The encoder-decoder machine learning model 308 is trained, in other words, to output the estimated second time-series execution performance information 304′ for a workload on the second hardware platform given the actual first time-series execution performance information 302 for the workload on the first hardware platform. During training, the actual second time-series execution performance information 304 collected during execution of the workload on the second hardware platform is known. Therefore, a loss function can be applied (410) to the actual and estimated second time-series execution performance information 304 and 304′ to determine a loss 412. The machine learning model 308 is thus trained to minimize the loss 412 (i.e., the loss function) for the training workloads.

During modeling, the encoder layers 406 and the decoder layers 408 can pad the time-series sequences (i.e., the time-series execution performance information 302 in the form as input to any given layer 406 or 408) to a maximum size. This is because some extracted workload sequences may be considerably larger than others, such that padding ensures that the encoder-decoder machine learning model 308 is guided towards efficient parameter learning. The sequences are similarly bounded by this maximum size, to ensure that no unbounded sequences occur.

The modeling also employs time-series execution performance information 302 and 304 that are discrete time series. That is, to the extent that the collection of the time-series execution performance information 302 and 304 concerns a continuous input signal, the continuous input signal is discretized so that the resulting collected execution performance information 302 and 304 are each a discrete time series. For example, the continuous input signal may be sampled at regular time periods as noted above, such as every millisecond, every second, and so on. This process may be considered as digitization or binarization of such a continuous input signal.

The usage of an encoder-decoder neural network, or other type of encoder-decoder machine learning model 308, is novel in the context of estimating time-series execution performance information of a workload on a second hardware platform given known time-series execution performance information of the workload on a first hardware platform. Encoder-decoder neural networks, including autoencoders, are more commonly used in the context of applications such as machine translation of text. Such neural networks can nevertheless be employed in modified form for in effect translating the time-series execution performance information collected during workload execution on a first hardware platform to the time-series execution performance information that would be collected if the workload were executed on a second hardware platform. An example of such a sequential mapping neural network used for machine translation is the sequence-to-sequence (seq2seq) machine learning model. Whereas the seq2seq model is a relatively complex recurrent neural network model, the encoder-decoder machine learning model 308 can be a more simplified autoencoder while still providing sufficiently accurate results.

Encoder-decoder neural networks have thus far been employed in the context of workload performance estimation just to forecast performance of a workload on a hardware platform given the known, prior performance on the same hardware platform. The novel usage of an encoder-decoder neural network, or other type of encoder-decoder machine learning model 308, for estimating time-series execution performance of a workload on a second hardware platform given known time-series execution performance of the workload on a first hardware platform is inventively distinct. For instance, the machine learning model training process described herein is different, using collected time-series execution workload performance on two platforms. By comparison, forecasting workload performance on a platform given prior workload performance on the platform necessarily has to consider information that affects performance of the workload on the platform in the future for such forecasts to be accurate.

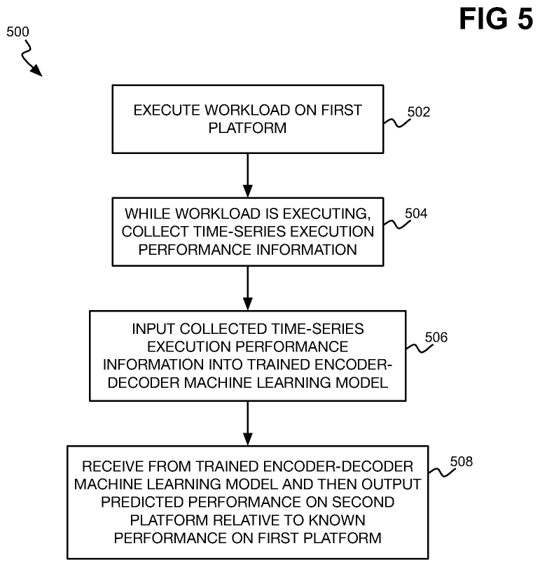

FIG. 5 shows an example method 500 for using the encoder-decoder machine learning model trained per FIGS. 1, 3, and 4 to predict performance of a workload on a second hardware platform relative to known performance of the workload on a first hardware platform. The encoder-decoder machine learning model was trained from execution performance information collected during execution of training workloads on the first and second platforms, as has been described. The method 500 can be implemented as a non-transitory computer-readable data storage medium storing program code executable by a computing device.

The method 500 includes executing a workload on the first hardware platform on which the machine learning model was trained (502). The first hardware platform on which the workload is executed may be the particular computing device on which the training workloads were previously executed for training the machine learning model. The first hardware platform may instead by a computing device having the same specifications—i.e., constituent hardware components having the same specifications—as the computing device on which the training workloads were previously executed.

The workload that is executed on the first hardware platform may be a workload that is normally executed on this first platform, and for which whether there would be a performance benefit in instead executing the workload on the second hardware platform is to be assessed without actually executing the workload on the second platform. Such an assessment may be performed to determine whether to procure the second hardware platform, for instance, or to determine whether subsequent executions of the workload should be scheduled on the first or second platform for better performance. The workload can include one or more processing tasks that specified application programs run on provided data in a provided order.

The method 500 includes, while the workload is executing on the first hardware platform, collecting time-series execution performance information of the workload on the first hardware platform (504). For example, the computing device performing the method 500 may transmit to the first hardware platform an agent computer program that collects the time-series execution performance information from the time that workload execution has started to the time that workload execution has finished. A user may initiate workload execution on the first hardware platform and then signal to the agent program that workload execution has started, and once workload execution has finished may similarly signal to the agent program that workload execution has finished. In another implementation, the agent program may initiate workload execution and correspondingly begin collecting time-series execution performance information, and stop collecting the execution performance information when workload execution has finished. The agent computer program may then transmit the time-series execution performance information that it has collected back to the computing device performing the method 500.

The time-series execution performance information that is collected on the first hardware platform includes the values of the same hardware and software statistics, metrics, counters, and traces that were collected for the training workloads during training of the machine learning model. Thus, the time-series execution performance information that is collected on the first hardware platform while the workload is executed includes execution traces for the same metrics that were collected for the training workloads. As with the training workloads, the execution performance information collected for the workload in part 504 does not include the workload itself, such as the specification application programs (including any code or any identifying information thereof) that are run as processing tasks as part of the workload, and such as the order in which the tasks are performed during workload execution. Similarly, the execution performance information does not include the (user) data on which the processing tasks are operative, or any identifying information of such (user) data.

Therefore, no part of the workload, including the data that has been processed during execution of the workload, is transmitted from the first hardware platform to the computing device performing the method 500. As such, confidentiality is maintained, and users who are particularly interested in assessing whether their workloads would benefit in performance if executed on the second hardware platform instead of on the first hardware platform can perform such analysis without sharing any information regarding the workloads. The information on which basis the encoder-decoder machine learning model predicts performance on the hardware platform relative to known performance on the first platform in the method 500 includes just the execution traces that were collected during workload execution on the first platform.

It is noted that while in the implementation of FIG. 5 the first hardware platform on which the workload is executed is the first hardware platform on which the machine learning model has been trained, the workload itself does not have to be—and will in all likelihood not be—any of the training workloads that were executed during machine learning model. The encoder-decoder machine learning model is trained from collected time-series execution performance information of training workloads on the first and second hardware platforms so that time-series execution performance information of any workload that is collected on the first platform can be used by the model to predict performance on the second hardware relative to known performance on the first platform. The machine learning model learns, from collected time-series execution performance information of training workloads on the both the first and second hardware platforms, how to predict from time-series execution performance information collected during execution of any workload part on the first platform, performance on the second platform relative to known performance on the first platform.

The method 500 includes inputting the collected time-series execution performance information into the trained encoder-decoder machine learning model (506). For instance, the agent computer program that collected the time-series execution performance information may transmit this collected information to the computing device performing the method 500, which in turn inputs the information into the encoder-decoder machine learning model. As another example, the agent program may save the collected time-series execution performance information on the first hardware platform or another computing device, and a user may upload or otherwise transfer the collected information via a web site or web service to the computing device performing the method 500.

The method 500 includes receiving from the trained machine learning model and then outputting predicted performance of the workload on the second hardware platform relative to known performance of the workload on the first hardware platform (508). The predicted performance can then be used in a variety of different ways. The predicted performance of the workload on the second hardware platform can be used to assess whether to procure the second hardware platform for subsequent execution of the workload. For example, a user may be contemplating purchasing a new computing device (viz., the second hardware platform), but be unsure as to whether there would be a meaningful performance benefit in the execution of the workload in question on the computing device as opposed to the existing computing device (viz., the first hardware platform) that is being used to execute the workload.

Similarly, the user may be contemplating upgrading one or more hardware components of the current computing device, but be unsure as to whether a contemplated upgrade will result in a meaningful performance increase in executing the workload. In this scenario, the current computing device is the first hardware platform, and the current computing device with the contemplated upgraded hardware components is the second hardware platform. For a workload that is presently being executed on a current or existing computing device, a user can therefore assess whether instead executing the workload on a different computing device (including the existing computing device but with upgraded components) would result in increased performance, without actually having to execute the workload on the different computing device in question.

The predicted performance can be used for scheduling execution of the workload within a cluster of heterogeneous hardware platforms including the first hardware platform and the second hardware platform. A scheduler is a type of computer program that receives workloads for execution, and schedules when and on which hardware platform each workload should be executed. Among the factors that the scheduler considers when scheduling a workload for execution is the expected execution performance of the workload on a selected hardware platform. For example, a given workload may during pre-deployment or preproduction have had to have been executed at least once on each different hardware platform of the cluster to predetermine performance of the workload on that platform. This information would then have been used when the workload was subsequently presented during production or deployment for execution, to select the platform on which to schedule execution of the workload.

By comparison, in the method 500, a workload that is to be scheduled for execution is executed on just the first hardware platform during pre-deployment or preproduction. When the workload is subsequently presented during production or deployment for execution, the scheduler can predict performance of the workload on the second platform relative to the known performance of the workload on the first platform, to schedule the platform on which to schedule execution of the workload. The usage of the machine learning model to predict workload performance on the second platform relative to the known workload performance on the first platform can instead also be performed during pre-deployment or preproduction, instead of at time of scheduling.

For example, when receiving a workload that has been previously executed on the first hardware platform, the scheduler may determine the predicted performance of the workload on the first hardware platform relative to the first hardware platform. The scheduler may then schedule the workload for execution on the platform at which better performance is expected. For instance, if the predicted performance of the workload on the second platform is such that the second platform is likely to take less time to complete execution of the workload (i.e., the predicted performance relative to the first platform is better), then the scheduler may schedule the workload for execution on the second platform, such that the workload is subsequently executed on the second platform. By comparison, if the predicted workload performance on the second platform is such that the second platform is likely to take more time to complete execution of the workload (i.e., the predicted performance relative to the first platform is worse), then the scheduler may schedule the workload for execution on the first platform, such that the workload is subsequently executed on the first platform.

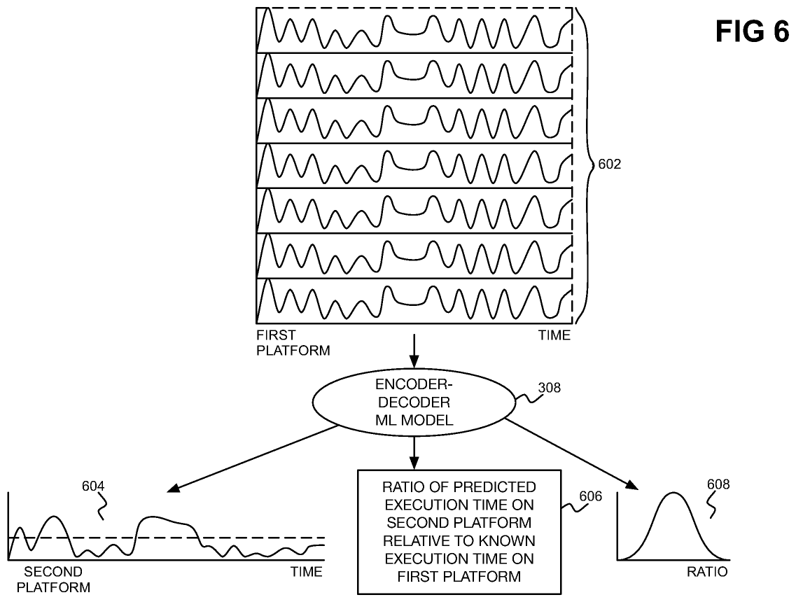

FIG. 6 illustratively shows example machine learning model usage in the method 500 of FIG. 5. A workload is executed on the first hardware platform and time-series execution performance information 602 of the same type collected during machine learning model training is collected and input into the encoder-decoder machine learning model 308. The encoder-decoder machine learning model 308 outputs the predicted performance of the workload on the second hardware platform relative to the known performance of the workload on the first hardware platform.

The predicted performance of the workload on the second hardware platform relative to the known performance of the workload on the first hardware platform can include one or multiple of the following. First, the actual estimated time-series execution performance information 604 of the workload on the second hardware platform may be output by the encoder-decoder machine learning model 308. Such estimated execution performance information 604 may be considered raw, fine-grained data that may be suitable for usage by a technical user, such as an engineer or other technical personnel, to assess predicted performance of the workload on the second platform relative to the known performance of the workload on the first platform. For instance, such a user may compare and contrast in detail the estimated time-series execution performance information 604 of the workload on the second platform with the known time-series execution performance information 602 on the first platform.

Second, a numeric ratio 606 of the predicted execution time of the workload of the workload on the second hardware platform to the known execution time of the first hardware platform may be output by the encoder-decoder machine learning model 308, or distilled from the information that the model 308 outputs. The actual time-series execution performance information 602 of the workload on the first platform may end at a first time after beginning at relative zero time, signifying that the workload was completed on the first platform at this first time. By comparison, the estimated time-series execution performance information 604 of the workload on the second platform may end at a different, second time after beginning at relative zero time, signifying that the workload is estimated to complete on the second platform at this second time. The numeric ratio 606 in this respect is the second time divided by the first time.

The numeric ratio 606 therefore is indicative of how much faster or slower it is expected to take the second hardware platform to execute the same workload as compared to the first hardware platform. If the ratio is less than one (i.e., less than 100%), therefore, then the second platform is predicted to execute the workload part more quickly than the first platform did. By comparison, if the ratio is greater than one (i.e., greater than 100%), then the second platform is predicted to execute the workload more slowly than the first platform did. Such information may be more suitable for usage by a user who is less interested in the specifics of predicted execution of the workload on the second platform (as the estimated time-series execution performance information 604 can provide) and who is more interested in whether the workload will likely be executed more quickly if executed on the second platform.

Third, a distribution 608 of the ratio 606 of the predicted execution time of the workload on the second hardware platform to the known execution time of the workload on the first hardware platform may be output by the encoder-decoder machine learning model 308, or distilled from the information that the model 308 outputs. For instance, such an encoder-decoder machine learning model 308 may indicate this distribution 608, or provide parameters that govern and define a standard distribution, such as a Gaussian distribution. The distribution 608 conforms to the confidence of the machine learning model 308 in the estimated time-series execution performance information 604 of the workload on the second platform. The more confident the model 308 is in its prediction of the ratio 606 of the predicted execution time of the workload on the second platform to the known execution time of the workload on the first platform, the narrower the distribution 608 having the predicted ratio 606 at the peak will be. By comparison, the less confident the model 308 is in its prediction of this ratio 606, the wider the distribution will be.

The distribution 608 of the ratio 606 of the predicted execution time of the workload on the second hardware platform to the known execution time of the workload on the first hardware platform may be useful to the same type of user who is interested in the ratio 606 itself. The distribution 608 of the ratio 606 permits a user to assess the confidence of the encoder-decoder machine learning model 308 in the provided numeric ratio 606. If the distribution 608 is relatively wide, for instance, the user can assess that the model 308 is less confident in the predicted workload performance on the second platform relative to the known workload performance on the first platform, as compared to if the distribution 608 is relatively narrow.

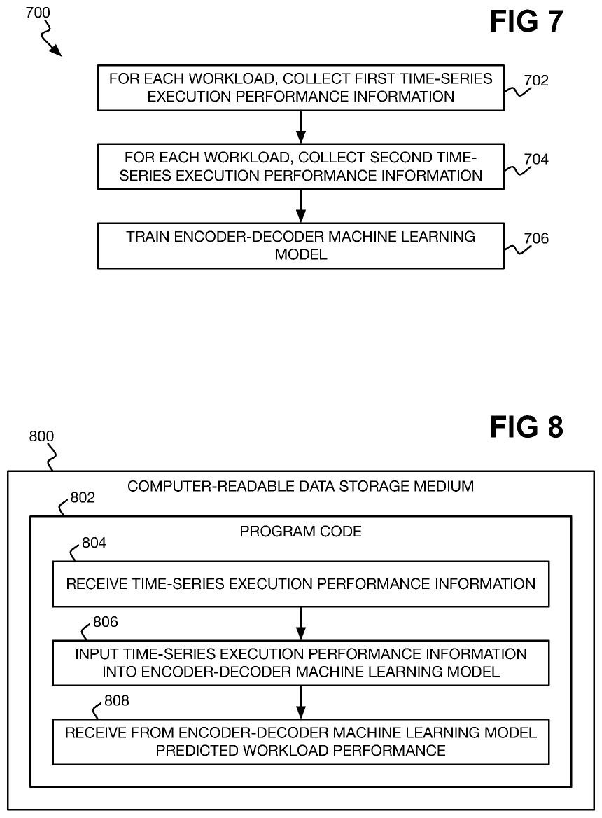

FIG. 7 shows an example method 700. The method 700 may be performed by a processor of a computing device, and may be implemented as program code stored on a non-transitory computer-readable data storage medium that is executed by the processor. The method 700 includes, for each of a number of workloads, collecting first time-series execution performance information during execution of the workload on a first hardware platform (702), and collecting second time-series execution performance information during execution of the workload on a second hardware platform (704). The method 700 includes training an encoder-decoder machine learning model that outputs predicted performance on the second hardware platform relative to known performance on the first hardware platform (706). The encoder-decoder machine learning model is specifically trained from the first and second time-series execution performance information for each workload.

FIG. 8 shows an example non-transitory computer-readable data storage medium 800 storing program code 802 executable by a processor of a computing device to perform processing. The processing includes receiving time-series execution performance information of a workload on a first hardware platform collected during execution of the workload on the first hardware platform (804). The processing includes inputting the time-series execution performance information into an encoder-decoder machine learning model (806). The model was trained from first and second time-series execution performance information collected during of training workloads on the first and second hardware platforms, respectively. The method includes receiving from the encoder-decoder machine learning model and then outputting predicted performance of the workload on the second hardware platform relative to known performance on the first hardware platform (808). For example, the predicted performance may be output via display on a display device of the computing device, and so on.

It is noted that the usage of the phrase hardware platforms herein encompasses virtual appliances or environments, as may be instantiated within a cloud computing environment or a data center. Examples of such virtual appliances and environments include virtual machines, operating system instances virtualized in accordance with container technology like DOCKER container technology or LINUX container (LXC) technology, and so on. As such, a platform can include such a virtual appliance or environment in the techniques that have been described herein.

An encoder-decoder machine learning model has been described that can predict workload performance on a target hardware platform relative to known workload performance on a source hardware platform. The encoder-decoder machine learning model can be trained without having to instrument source code of training workloads, and without having to correlate time intervals between time-series execution performance information on the source and target platforms. The resultantly trained encoder-decoder machine learning model can therefore have better accuracy in predicting workload performance on the target platform relative to known workload performance on the source platform as compared to other types of machine learning models.

We claim:

1. A method comprising:
for each of a plurality of workloads, collecting first time-series execution performance information during execution of the workload on a first hardware platform;
for each workload, collecting second time-series execution performance information during execution of the workload on a second hardware platform; and
training an encoder-decoder machine learning model that outputs predicted performance on the second hardware platform relative to known performance on the first hardware platform, the encoder-decoder machine learning model trained from the first and second time-series execution performance information for each workload.

2. The method of claim 1, further comprising:
using the trained encoder-decoder machine learning model to predict performance of a workload on the second hardware platform relative to the known performance on the first hardware platform, by inputting into the encoder-decoder machine learning model time-series execution performance information that was collected during execution of the workload on the first hardware platform.

3. The method of claim 2, wherein the encoder-decoder machine learning model outputs one or multiple of:
estimated time-series execution performance information of the workload on the second hardware platform;
a numeric ratio of a predicted execution time of the workload on the second hardware platform to a known execution time of the workload on the first hardware platform;
an estimated distribution of a ratio of the predicted execution time of the workload on the second hardware platform to the known execution time of the workload on the first hardware platform.

4. The method of claim 1, further comprising:
executing each workload on the first hardware platform, wherein the first time-series execution performance information is collected while each workload is executing on the first hardware platform; and
executing each workload on the second hardware platform, wherein the second time-series execution performance information is collected while each workload is executing on the second hardware platform.

5. The method of claim 1, wherein the first and second time-series execution performance information are each collected at identical fixed time intervals.

6. The method of claim 1, wherein, for each workload, the first and second time-series execution performance information each comprise values of hardware and software statistics, metrics, counter, and/or traces over time as the workload is executed.

7. The method of claim 1, wherein the encoder-decoder machine learning model is trained and subsequently used to predict performance on the second hardware platform relative to the known performance on the first hardware platform without using any identifying information of any application code run during execution of any workload or any identifying information of any user data of any workload.

8. A non-transitory computer-readable data storage medium storing program code executable by a processor to perform processing comprising:
receiving time-series execution performance information of a workload on a first hardware platform collected during execution of the workload on the first hardware platform;
inputting the time-series execution performance information into an encoder-decoder machine learning model trained from first and second time-series execution performance information collected during execution of a plurality of training workloads on the first and second hardware platforms, respectively; and
receiving from the encoder-decoder machine learning model and then outputting predicted performance of the workload on the second hardware platform relative to known performance on the first hardware platform.

9. The non-transitory computer-readable data storage medium of claim 8, further comprising:
executing the workload on the second hardware platform if the predicted performance of the workload on the second hardware platform is better than known performance of the workload on the first hardware platform; and
executing the workload on the first hardware platform if the predicted performance of the workload on the second hardware platform is worse than the known performance of the workload on the first hardware platform.

10. The non-transitory computer-readable data storage medium of claim 8, wherein the predicted performance of the workload is used to assess whether to procure the second hardware platform for executing the workload.

11. The non-transitory computer-readable data storage medium of claim 8, wherein receiving and outputting the predicted performance of the workload on the second hardware platform relative to the first hardware platform comprises:
receiving and outputting estimated time-series execution performance information of the workload on the second hardware platform.

12. The non-transitory computer-readable data storage medium of claim 8, wherein receiving and outputting the predicted performance of the workload on the second hardware platform relative to the first hardware platform comprises:
receiving and outputting a numeric ratio of a predicted execution time of the workload on the second hardware platform to a known execution time of the workload on the first hardware platform.

13. The non-transitory computer-readable data storage medium of claim 8, wherein receiving and outputting the predicted performance of the workload on the second hardware platform relative to the first hardware platform comprises:
receiving and outputting an estimated distribution of a ratio of a predicted execution time of the workload on the second hardware platform to a known execution time of the workload on the first hardware platform.

14. The non-transitory computer-readable data storage medium of claim 8, wherein the time-series execution performance information comprises values of hardware and software statistics, metrics, counter, and/or traces over time as the workload is executed on the first hardware platform.

15. The non-transitory computer-readable data storage medium of claim 8, wherein the encoder-decoder machine learning model estimates the predicted performance of the workload on the second hardware platform relative to the known performance on the first hardware platform without using any identifying information of any application code run during execution of the workload on the first hardware platform or any identifying information of any user data of the workload.
